(19) United States
(12) Patent Application Publication
(10) Pub. No.: US 2026/0043295 A1
(43) Pub. Date: Feb. 12, 2026

(54) COMPOSITE SHUTTERS HAVING METALLIC FRAMES

(71) Applicant: Houston Shutters, LLC, Houston, TX (US)

(72) Inventors: Jennifer Baur, Houston, TX (US); Michael Blackburn, Houston, TX (US)

(73) Assignee: Houston Shutters, LLC, Houston, TX (US)

(21) Appl. No.: 19/294,926

(22) Filed: Aug. 8, 2025

Related U.S. Application Data
(60) Provisional application No. 63/681,527, filed on Aug. 9, 2024.

(51) Int. Cl. E06B 9/04

(52) U.S. Cl. CPC E06B 9/04

(57) ABSTRACT

A composite shutter assembly includes a metallic shutter frame including a pair of elongate side members and a pair of elongate cross members extending between the pair of side members, and a nonmetallic shutter panel including a first stile pivotally coupled to a first side member of the pair of side members of the metallic shutter frame, the nonmetallic shutter panel configured to swing between a closed position and an open position relative to the metallic shutter frame.

### CROSS-REFERENCE TO RELATED APPLICATIONS

This application claims benefit of U.S. provisional patent application Ser. No. 63/681,527 filed Aug. 9, 2024, and entitled “Composite Shutters Having Metallic Frames,” which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to frames for holding objects or for aesthetically accenting objects. More particularly, it relates to frames for holding shutter panels, and to assemblies of frames and shutter panels that are applicable for installation adjacent windows or doors.

The design, fabrication, assembly, and installation of shutters (i.e. shutter panels or shutter assemblies) for window and door openings or casings can add storm protection, privacy, or aesthetic beauty to homes and other buildings. Some shutters are functional, such as panels that pivotally mount to a window or door casing, allowing the panels to be selectively pivoted to cover a window or door opening or pivoted to the side of the opening. Other shutters are cosmetic, giving aesthetic appeal without allowing movement. Panels for functional or cosmetic shutters commonly include a series of louvers, e.g. over-lapping boards. For functional shutters, the louvers may be pivotable or may be rigid relative to a panel frame.

Design features that improve the appearance or performance of shutters; that reduce manufacturing, assembly, and/or transportation costs; and/or that simplify the assembly of shutters are desirable to maintain an economic or other competitive advantage.

### BRIEF SUMMARY OF THE DISCLOSURE

An embodiment of a composite shutter assembly comprises a metallic shutter frame comprising a pair of elongate side members and a pair of elongate cross members extending between the pair of side members, and a nonmetallic shutter panel comprising a first stile pivotally coupled to a first side member of the pair of side members of the metallic shutter frame, the nonmetallic shutter panel configured to swing between a closed position and an open position relative to the metallic shutter frame. In some embodiments, the first side member of the metallic shutter frame includes an inwardly-facing frame surface in a region between the pair of cross members, and a frame-ledge. In some embodiments, each of the pair of side members and the pair of cross members each comprise metallic materials. In certain embodiments, the metallic shutter frame comprises aluminum. In certain embodiments, the nonmetallic shutter panel comprises at least one of a wooden material or a plastic material. In some embodiments, the nonmetallic shutter panel further comprises afront shutter-face, a perimeter shutter-face, and a rear shutter-face opposite the front shutter-face, and the metallic shutter frame defines a first surface parallel and facing the rear shutter face of the nonmetallic shutter panel when the nonmetallic shutter panel is closed, and an additional second surface parallel and facing the perimeter shutter-face when the nonmetallic shutter panel is closed. In some embodiments, the composite shutter assembly comprises a plurality of hinges having at least one mounting plate mounted to the nonmetallic shutter panel or at least one mounting plate coupled to the metallic shutter frame. In certain embodiments, at least one of a ratio of a width of a front frame-face of the metallic shutter frame to a width of one of the side members or cross members of the metallic shutter frame is between 0.1 and 0.3, a ratio of a thickness of a front frame-face of the metallic shutter frame to the width of one of the side members or cross members of the metallic shutter frame is between 0.1 and 0.2, or a ratio of a thickness of the front frame-face of the metallic shutter frame to a depth of one of the side members or cross members of the metallic shutter frame is between 0.1 and 0.3.

An embodiment of a composite shutter assembly comprises a metallic shutter frame comprising a pair of elongate side members and a pair of elongate cross members extending between the pair of side members, and a nonmetallic shutter panel comprising a first stile moveably coupled to a first side member of the pair of side members of the metallic shutter frame, the nonmetallic shutter panel configured to shift between a closed position and an open position relative to the metallic shutter frame. In certain embodiments, at least one of a ratio of a width of a front frame-face of the metallic shutter frame to a width of one of the side members or cross members of the metallic shutter frame is between 0.1 and 0.3, a ratio of a thickness of a front frame-face of the metallic shutter frame to the width of one of the side members or cross members of the metallic shutter frame is between 0.1 and 0.2, or a ratio of a thickness of the front frame-face of the metallic shutter frame to a depth of one of the side members or cross members of the metallic shutter frame is between 0.1 and 0.3. In some embodiments, the first side member of the metallic shutter frame includes an inwardly-facing frame surface in a region between the pair of cross members, and a frame-ledge. In some embodiments, each of the pair of side members and the pair of cross members each comprise metallic materials. In certain embodiments, at least one of the metallic shutter frame comprises aluminum or the nonmetallic shutter panel comprises at least one of a wooden material or a plastic material.

An embodiment of a composite shutter assembly comprises a metallic shutter frame comprising a first side member and a second side member, a first cross member and a second cross member extending between the first side member and the second side member and spaced apart from one another, wherein at least one of the first side member, the second side member, the first cross member, or the second cross member comprises a metallic material, and a nonmetallic shutter panel pivotally coupled to the metallic shutter frame, the nonmetallic shutter panel comprising a first stile and a second stile, and a first rail and a second rail extending between the first stile and the second stile and spaced apart from one another, and a louver pivotably coupled to the first stile and the second stile, wherein at least one of the first stile, the second stile, the first rail, the second rail, or the louver comprises a nonmetallic material. In certain embodiments, at least one of the metallic material comprises aluminum or the nonmetallic material comprises at least one of a wooden material or a plastic material. In some embodiments, the first side member of the metallic shutter frame includes an inwardly-facing frame surface in a region between the first cross member and the second cross member, and a frame-ledge. In some embodiments, each of the first side member, the second side member, the first cross member, and the second cross member comprise metallic materials. In certain embodiments, the composite shutter assembly comprises one or more hinges having at least one mounting plate mounted to the nonmetallic shutter panel or at least one mounting plate coupled to the metallic shutter frame. In certain embodiments, at least one of a ratio of a width of a front frame-face of the metallic shutter frame to a width of one of the side members or cross members of the metallic shutter frame is between 0.1 and 0.3, a ratio of a thickness of a front frame-face of the metallic shutter frame to the width of one of the first side member and the second side member or cross members of the metallic shutter frame is between 0.1 and 0.2, or a ratio of a thickness of the front frame-face of the metallic shutter frame to a depth of one of the side members or cross members of the metallic shutter frame is between 0.1 and 0.3 In some embodiments, the metallic shutter frame has an L-shaped cross-section comprising a first frame member and a second frame member extending orthogonally the second frame member.

Thus, the various embodiments described herein comprise a combination of features and characteristics intended to address various shortcomings associated with certain prior devices, systems, and methods. The various features and characteristics described above, as well as others, will be readily apparent to those of ordinary skill in the art upon reading the following detailed description, and by referring to the accompanying drawings.

### BRIEF DESCRIPTION OF THE DRAWINGS

For a detailed description of the disclosed exemplary embodiments, reference will now be made to the accompanying drawings in which:

FIG. 1 is a perspective front view of a composite shutter assembly in accordance with principles described herein, the assembly shown with a nonmetallic shutter panel of the assembly slightly open in accordance with the principles disclosed herein;

FIG. 2 is a front elevation view of the frame of the composite shutter assembly of FIG. 1;

FIG. 3 is a top-down view of the composite shutter assembly of FIG. 1;

FIG. 4 is a perspective view of an embodiment of a metallic shutter frame of the shuttle assembly of FIG. 1 in accordance with principles disclosed herein;

FIG. 5 is a top-down cross-sectional view of the metallic shutter frame of FIG. 4;

FIG. 6 is a perspective cross-sectional view of the composite shutter assembly of FIG. 1;

FIG. 7 is a top-down cross-sectional view of the composite shutter assembly of FIG. 1; and

FIG. 8 is a top-down cross-sectional view of the composite shutter assembly of FIG. 1, the assembly shown with the nonmetallic shutter panel of the assembly closed in accordance with principles disclosed herein.

### NOTATION AND NOMENCLATURE

The following description is exemplary of certain embodiments of the disclosure. One of ordinary skill in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness. In some of the figures, in order to improve clarity and conciseness of the figure, one or more components or aspects of a component may be omitted or may not have reference numerals identifying the features or components that are identified elsewhere. In addition, among the drawings, like or identical reference numerals may be used to identify common or similar elements.

The terms “including” and “comprising” are used herein including the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, X may be based on Y and any number of other factors.

In addition, as used herein including the claims, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to a given axis, and a radial distance means a distance measured perpendicular to the axis. Distances between surfaces, faces, or objects are to be measured as the perpendicular distances between those features or between geometric extensions of those features. As understood in the art, the use of the terms “parallel” and “perpendicular” may refer to precise or idealized conditions as well as to conditions in which the members may be generally parallel or generally perpendicular, respectively. Any reference to a relative direction with respect to an object, for example “top,” “bottom,” “up”, “upward,” “left,” “leftward,” “left-hand,” “right-hand,” “down”, and “lower” is made for purpose of clarification and pertains to the orientation of a particular FIG. or embodiment being described. If the object were viewed from another orientation or implemented in another orientation, it may be appropriate to described direction using an alternate term.

### DETAILED DESCRIPTION

This disclosure presents a frame and a shutter panel, which may be formed into a shutter assembly, all of which are applicable to fenestration, i.e. window and door openings, frames, or casings. In various embodiments, the shutter assembly includes one or more shutter panels coupled to a frame. The shutter panel may include multiple louvers. In at least some embodiments, the shutter assembly is functional, having a shutter panel pivotally mounted to the frame, allowing the panel to be selectively positioned within the window or door opening or to the side of the opening. That is to say, the shutter panel is configured to swing between a closed position and an open position relative to the frame. Various embodiments disclosed herein have improved light-blocking capability as compared to traditional shutters.

Existing shutter assemblies for indoor use (e.g., excluding external or outdoor storm shutters and the like) are generally made from nonmetallic materials such as wooden materials and/or plastic or polymeric materials such as polyvinyl chloride (PVC) intended to desirably mimic the appearance of wooden materials. Particularly, indoor shutter assemblies generally include a shutter panel supported in a surrounding shutter frame of the assembly where each of the shutter panel and shutter frame comprise nonmetallic materials. Indeed, the shutter assembly may include, at most, fasteners (e.g., hinges, connecting pins, gears) made from metallic materials with the shutter frame and shutter panel (e.g., shutter stiles, rails, louvers) formed form nonmetallic materials.

Additionally, the shutter frame and shutter panel of conventional shutter assemblies are typically formed from the same material. For example, for an indoor shutter assembly, the shutter frame and shutter panel (excluding at least some of the fasteners of the shutter assembly in some instances) are formed from either wooden or plastic materials. Conversely, storm shutters for outdoor use (e.g., for protecting a window in the event of a storm) may be formed substantially or entirely from metallic materials given the rougher environment in which the outdoor shutter assembly is used and the relatively greater loading the outdoor shutter assembly is subjected to during operation. In other words, conventional shutter assemblies are generally not composite in the form of mixing a metallic shutter frame with a nonmetallic shutter panel or vice-a-versa.

However, disclosed herein are embodiments of composite shutter assemblies for indoor use including a metallic shutter frame and a nonmetallic (e.g., wooden and/or plastic) shutter panel moveably (e.g., pivotably, slidably) coupled to the metallic shutter frame. Generally speaking, the aluminum shutter frame has relatively greater strength and resiliency relative to similarly shaped nonmetallic shutter frame. For instance, the of the metallic shutter frame (which may be welded together in some embodiments) may be more difficult to separate due to loading applied from corresponding one or more shutter panels moveably coupled therewith. This enhanced strength and resiliency may in turn be leveraged to optimize (e.g., minimize) selected geometric parameters of the shutter frame (e.g., a thickness or cross-sectional area of the shutter frame) while maintaining a desired degree of strength and resiliency in the optimized shutter frame. For instance, in some embodiments, a thickness of the shutter frame may be reduced by over 75% (e.g., reduced from 1″ to ⅛″ as an example) by utilizing metallic materials (e.g., aluminum) rather than nonmetallic materials.

The optimized or thin metallic shutter frame provides several advantages particularly when paired with a nonmetallic shutter panel for indoor use. For example, the thin profile of the metallic shutter frame provides the frame with superior adaptability to various types of existing window trims—permitting the thin metallic shutter frame to desirably “blend in” to the surrounding window trim. Moreover, in spite of having optimized or minimized geometric parameters (e.g., thickness), embodiments of metallic shutter frames may still have greater strength and resiliency than relatively thicker or more robustly shaped nonmetallic shutter frames, particularly for larger window sizes. This greater strength and resiliency of the metallic shutter frame may facilitate installation by better resisting common issues like bowing than relatively less rigid nonmetallic shutter frames. Moreover, the metallic shutter frame may be made straighter (in addition to resisting bowing) than corresponding nonmetallic shutter frames whereby light leakage past the shutter frame may be minimized relative to corresponding nonmetallic shutter frames.

Moreover, given that the shutter frame is located adjacent the window trim and thus directly interfaces with the window itself (e.g., is part of the “window envelope), the shutter frame may be more likely to come into contact with moisture from the outdoor environments than the shutter panel, where metallic materials are generally more corrosion resistant. This corrosion resistance may be leveraged even in indoor shutter assemblies by providing the assembly with a metallic shutter frame paired with an aesthetically desirable nonmetallic shutter panel. Further, the metallic shutter frame may weigh substantially less than a nonmetallic shutter frame of comparable size (e.g., fitting a comparably sized window), making a composite shutter assembly including a metallic shutter frame easier to transport and install.

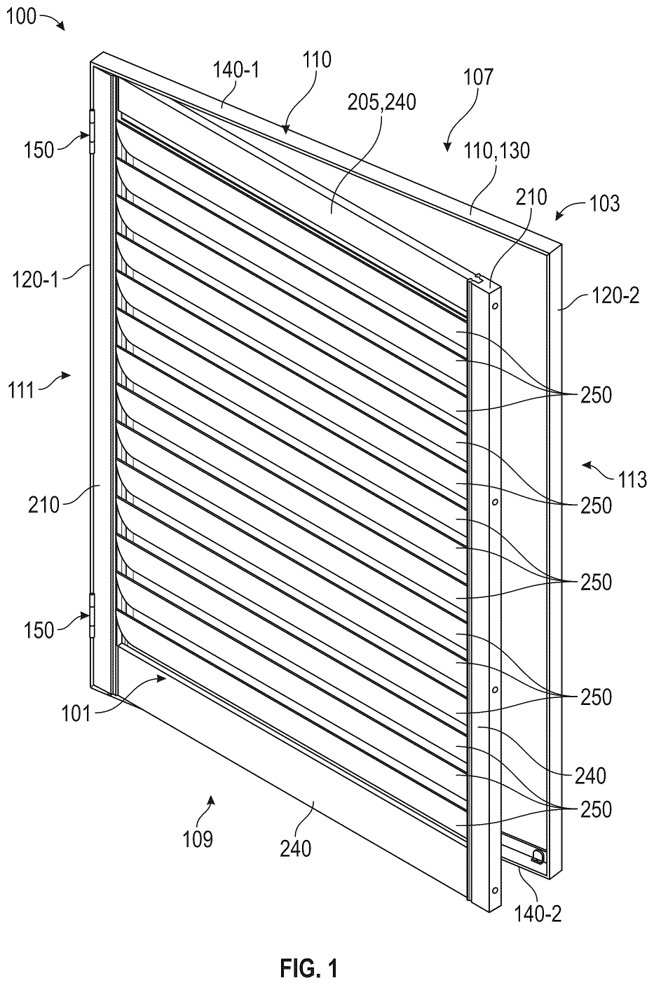

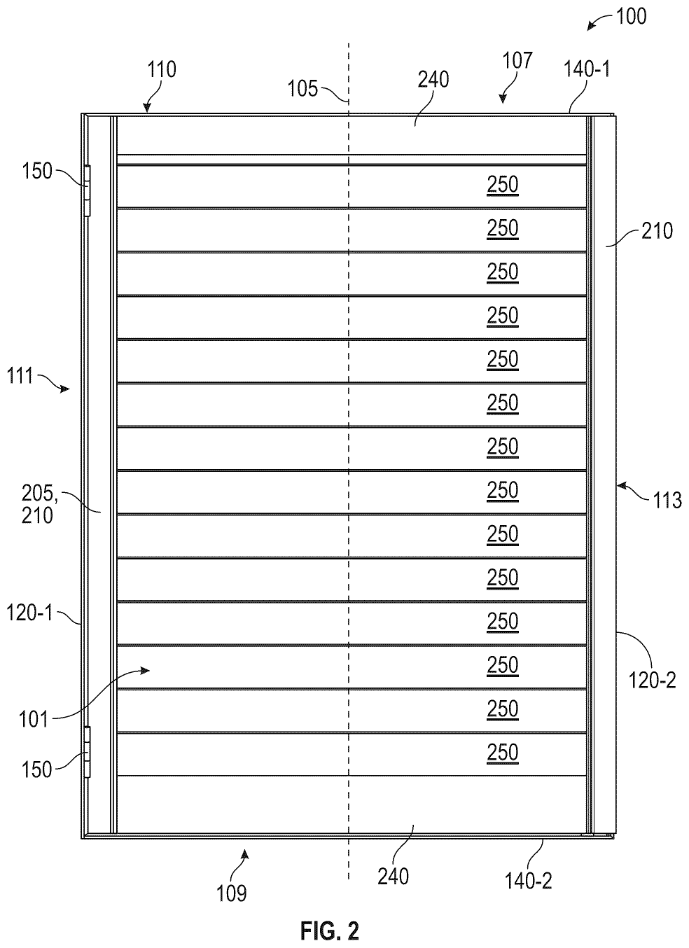

Referring to FIGS. 1-3 an exemplary embodiment of a composite shutter assembly 100 is shown. Composite shutter assembly 100 has an interior side 101, an exterior side 103 opposite the interior side 101, a vertically upper end 107, a vertically lower end 109 opposite upper end 107 along a longitudinal or central axis 105 (shown in FIG. 2) of composite shutter assembly 100, a first lateral side 111, and a second lateral side 113 opposite the first lateral side 111. In this exemplary embodiment, composite shutter assembly 100 comprises an indoor composite shutter assembly for indoor use such that the composite shutter assembly 100 is positioned on the interior or indoor side of a given window covered by the composite shutter assembly 100. Composite shutter assembly 100 generally includes a metallic shutter frame 110 and one or more nonmetallic shutter panels moveably coupled to metallic shutter frame 110 by at least one rotatable coupler. In this embodiment, one or more shutter panels is a louvered, nonmetallic shutter panel 200 having rotatable louvers that is moveably (e.g., pivotably) coupled to metallic shutter frame 110 by a pair of rotatable couplers in the form of hinges 150. In this exemplary embodiment, nonmetallic shutter panel 200 is pivotably coupled to the metallic shutter frame 110. However, in other embodiments, nonmetallic shutter panel 200 may instead be slidably coupled and the like with metallic shutter frame 110. In FIG. 1, nonmetallic shutter panel 200 is shown in FIGS. 1-3 in a partially open position or open configuration where the nonmetallic shutter panel 200 is rotationally displaced from metallic shutter frame 110.

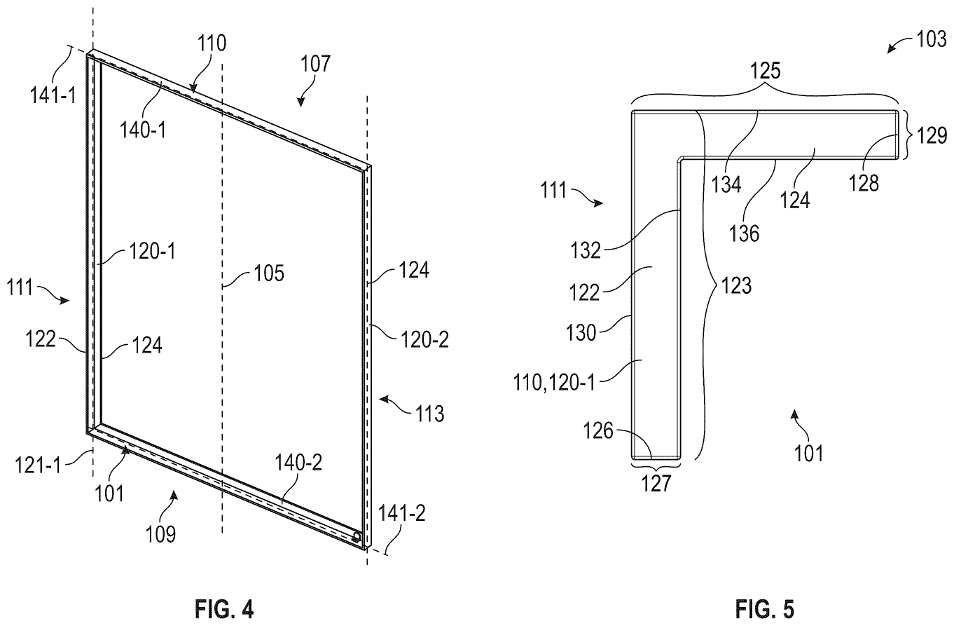

Referring now to FIG. 4 and FIG. 5, additional views of the metallic shutter frame 110 of composite shutter assembly 100 are shown. Generally, metallic shutter frame 110 includes multiple side members and multiple cross members extending between the side members. In this example, metallic shutter frame 110 includes a pair of elongate side members 120 (shown as side members 120-1 and 120-2 in FIGS. 4 and 5) extending parallel central axis 105 and a pair of elongate, generally parallel cross members 140 (shown as cross members 140-1 and 140-2 in FIGS. 4 and 5) spaced-apart from one another and extending laterally and orthogonally between the side members 120 (e.g., between lateral sides 111 and 113 of composite shutter assembly 100). Each side member 120 extends along a separate longitudinal axis, which may be called a side member axis 121 (shown as side member axes 121-1 and 121-2 in FIGS. 4 and 5, respectively) and may be centered left-to-right or front-to-back through the side member or may pass through the center of mass. Upper and lower cross members 140-1 and 140-2, respectively, each extend along a separate longitudinal axis, which may be called a cross member axes 141 (shown as cross member axes 141-1 and 141-2 in FIGS. 4 and 5, respectively), and may be centered left-to-right or front-to-back through the side member or may pass through the center of mass. In the orientation shown for metallic shutter frame 110, side members 120 are vertical, and cross members 140 are horizontal.

A detailed discussion of an exemplary embodiment of a side member 120 of metallic shutter frame 110 follows herein. In at least some embodiments, cross members 140 of metallic shutter frame 110 may be configured similarly as side members 120 and thus the following discussion is also applicable to some embodiments of cross members 140. As shown particularly in FIG. 5, in this exemplary embodiment, each side member 120 comprises a generally rectangular first frame member 122 having a depth 123 extending between the interior side 101 and the exterior side 103, and a generally rectangular second frame member joined 124 coupled to the first frame member 122 and having a width 125 extending between lateral sides 111 and 113 orthogonal the first frame member 122. Particularly, first frame member 122 extends depthwise between a first or free end 126 and an opposing second or fixed end coupled to the second frame member 124. Similarly, second frame member 124 extends widthwise between a first or free end 128 (spaced from the free end 126 of first frame member 122) and an opposing second or fixed end coupled to the fixed end of first frame member 122. In some embodiments, frame members 122 and 124 are formed integrally or monolithically to form each side member 120. In other embodiments, frame members 122 and 124 may be initially formed separately from each other and later coupled such as via welding or other means (e.g., on more fasteners).

In some embodiments, the lateral thickness 127 and/or medial thickness 129 of each side member 120 is approximately between 0.10 inches (″) and 0.25″, the depth 123 is approximately between 1.0″ and 1.20″, and the width 125 is approximately between 1.3″ and 1.4″. The sizes of these geometrical parameters, and particularly those of thicknesses 127 and 129 may be substantially less than that of conventional nonmetallic shutter frames. However, the magnitudes of these various geometrical parameters of metallic shutter frame 110 may vary in other embodiments. Additionally, in some embodiments, the lateral thickness 127 is equal to the medial thickness 129. In other embodiments, lateral thickness 127 varies from the medial thickness 129. In some embodiments, a ratio of lateral thickness 127 to the width 125 is between 0.1 and 0.3. In some embodiments, a ratio of lateral thickness 127 to the width 125 is between 0.1 and 0.2. In certain embodiments, a ratio of lateral thickness 127 to the depth 123 is between 0.1 and 0.3. In certain embodiments, a ratio of lateral thickness 127 to the depth 123 is between 0.1 and 0.2.

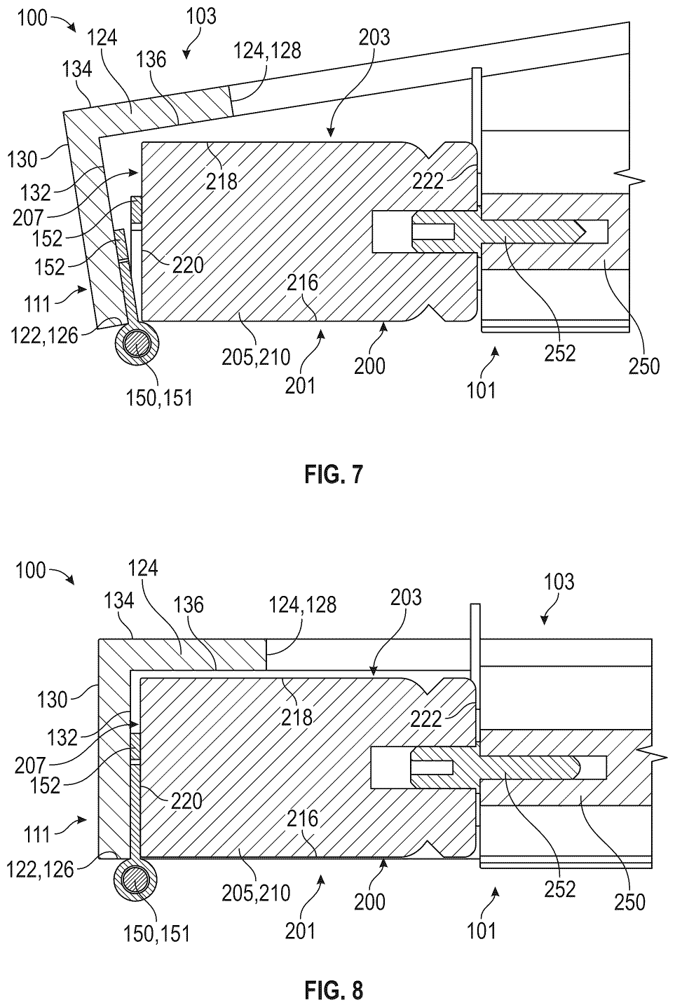

The first frame member 122 of each side member 120 has a lateral (e.g., extending between lateral sides 111 and 113) thickness 127 extending between an outer lateral surface 130 and an opposing inner lateral surface 132 of first frame member 122. Additionally, the second frame member 124 of each side member 120 has a medial (e.g., extending medially between sides 101 and 103) thickness 129 extending between an outer medial surface 134 and an opposing inner medial surface 136 of second frame member 124. partially defines the interior side 101 of composite shutter assembly 100 and thus is visible to the user (e.g., the occupant of the home in which composite shutter assembly 100 is installed). By minimizing lateral thickness 152, the visible “footprint” of metallic shutter frame 110 along the interior side 101 may be minimized, enhancing the adaptability of metallic shutter frame 110 with respect to an accompanying window trim of a window in which composite shutter assembly 100 is mounted. In other words, by minimizing lateral thickness 152 of first frame member 122 allows the metallic shutter frame 110 to effectively blend into the surrounding window trim such that the metallic shutter frame 110 may readily adapt (e.g., aesthetically, functionally, mechanically) with the surrounding window trim. The free end 126 of first frame member 122 forms a front-fame face of metallic shutter frame 110 while the outer medial surface 134 of second frame member 124 forms a rear-frame face of metallic shutter frame 110. Additionally, the surfaces 132 and 134 of each side member 120 may define an interior frame face of the metallic shutter frame 110 while free end 128 of second frame member 124 may define a light blocking frame ledge of metallic shutter frame 110 forming alight-blocking feature extending in afront-to-back direction. Further, nonmetallic shutter panel 200 is coupled to one of the side members 120 of metallic shutter frame 110 by a pair of hinges 150, in this exemplary embodiment, each pair of hinges having a common axis of rotation 151 (shown in FIG. 7) parallel to the side member 120.

In addition, metallic shutter frame 110 physically supports the nonmetallic shutter panel 200 and thus must provide sufficient mechanical strength and rigidity to support the nonmetallic shutter panel 200 without succumbing to excessive deformation or strain during use. For example, the metallic shutter frame 110 is responsible for vertically orienting the nonmetallic shutter panel 200 such that nonmetallic shutter panel 200 extends vertically (e.g., parallel side member axes 121) in both the open and closed configurations. In this exemplary embodiment, metallic shutter frame 110 is formed from a metallic material to permit both the optimization of one or more geometric parameters of metallic shutter frame 110 (e.g., minimization of lateral thickness 127 and/or medial thickness 129) while providing metallic shutter frame 110 with sufficient (or even enhanced relative to conventional shutter frames formed from nonmetallic materials) physical strength and rigidity for properly supporting and orienting nonmetallic shutter panel 200 in both the open and closed positions. The metallic shutter frame 110 is formed from a metallic material having a greater mechanical strength (e.g., resilience to compressive, tension, torsional, and/or bending loads) and/or rigidity (e.g., resilience to strain or deformation) relative to nonmetallic materials such as wooden materials and plastic materials such as PVC, for example.

The metallic material forming metallic shutter frame 110 may vary depending on the given application. In some embodiments, metallic shutter frame 110 is formed from an aluminum material (e.g., aluminum or an aluminum alloy) in order to minimize the weight of metallic shutter frame 110 to enhance the convenience in installing the composite shutter assembly 100 into its corresponding window. In other embodiments, metallic shutter frame 110 may comprise other metallic materials (including metallic alloys) such as steel, for example, when additional strength (e.g., for larger window sizes) or corrosion resistance is desired. In some embodiments, an exterior coating is applied to the metallic material forming metallic shutter frame 110 such as a powder coating, for example, to enhance the aesthetic appearance (e.g., powder coating the metallic shutter frame 110 to match a desired color) and/or for functional purposes such as enhancing the corrosion resistance of the metallic shutter frame 110.

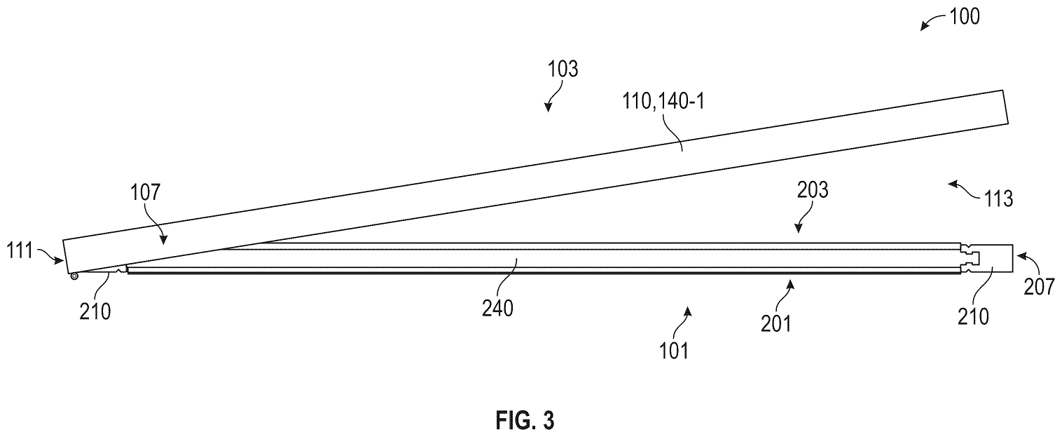

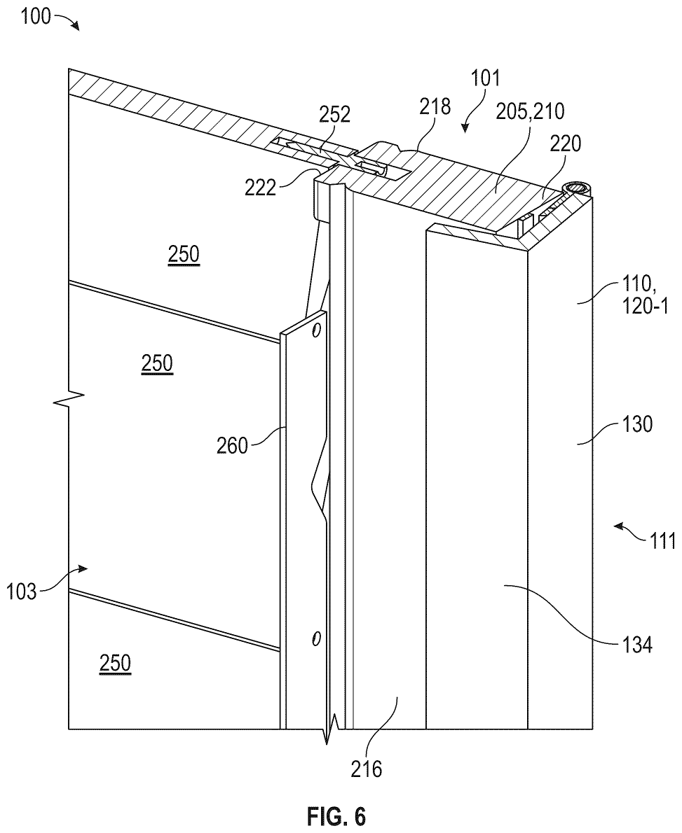

Referring to FIGS. 1-3, and 6-8, additional views of the nonmetallic shutter panel 200 and composite shutter assembly 100 are provided in FIGS. 6-8. Particularly, FIGS. 6 and 7 illustrate nonmetallic shutter panel 200 in the open position while FIG. 8 illustrates nonmetallic shutter panel 200 in the closed position. As shown particularly in FIG. 3, nonmetallic shutter panel 200 includes a front shutter-face 201, a rear shutter-face 203 opposite front shutter-face 201, and a perimeter shutter-face 207 located between the front shutter-face 201 and the rear shutter-face 203. The front shutter-face 201 may be coincident (e.g., located along the same side of composite shutter assembly 100) with the interior side of composite shutter assembly 100 while rear shutter-face 203 may be coincident the exterior side 103 of the composite shutter assembly 100 when the nonmetallic shutter panel 200 is in the closed position.

In this exemplary embodiment, nonmetallic shutter panel 200 generally includes a panel frame 205, multiple louvers 250, and a lifting bar 260 coupled to the louvers by fasteners (not shown) that allow relative movement between louvers 250 and bar 260. Panel frame 205 includes a pair of parallel, spaced-spaced apart stiles 210 and a pair of parallel rails 240 that are spaced-apart and that extend between and generally perpendicularly to the stiles 210. Louvers 250 are elongate and have two cylindrical axis pins 252 mutually aligned and extending from opposing ends of louver 250. In this example, each pin 252 is received within a hole formed within louver 250. In the assembled nonmetallic shutter panel 200, the two pins 252 rotationally couple the louver 250 between the two stiles 210, parallel to rails 240.

In this exemplary embodiment, and as shown particularly in FIGS. 7 and 8, each stile 210 of nonmetallic shutter panel 200 includes four separate faces or surfaces: a front stile-face 216, a rear stile-face 218, an elongate perimeter stile-face 220 between the stile-faces 216, 218, and an inside stile-face 222 distal the perimeter stile-face 220. When stile 210 is assembled into nonmetallic shutter panel 200, perimeter stile-face 220 is an elongate shutter surface located along the perimeter of nonmetallic shutter panel 200, and is located adjacent the inner lateral surface 132 of first side member 120-1 when the nonmetallic shutter panel 200 is in the closed position. Additionally, rear stile-face 218 is located adjacent the inner medial surface 136 of first side member 120-1 when the nonmetallic shutter panel 200 is in the closed position.

In some embodiments, the inner lateral surface 132 extends parallel and faces the perimeter shutter-face 207 of nonmetallic shutter panel 200 when the nonmetallic shutter panel 200 is in the closed position. Additionally, the inner lateral surface 132 may extend orthogonal front shutter-face 201 and rear shutter-face 203 of nonmetallic shutter panel 200 when nonmetallic shutter panel 200 is in the closed position. In certain embodiments, the inner medial surface 136 extends parallel and faces the rear shutter-face 203 of nonmetallic shutter panel 200 when the nonmetallic shutter panel 200 is in the closed position. Additionally, the inner medial surface 136 may extend orthogonal the perimeter shutter-face 207 when nonmetallic shutter panel 200 is in the closed position.

The rotatable couplers, which in this exemplary embodiment comprise a pair of non-mortise hinges 150, pivotally couple the nonmetallic shutter panel 200 to the metallic shutter frame 110. Each hinge 150 includes a pair of mounting plates 152 displaced from one another along the axis of rotation 151. Each mounting plate 152 has a pair of generally planer surfaces separated by the plate thickness T, and when rotated to be aligned end-to-end (as occurs when a nonmetallic shutter panel 200 is closed for example), the surfaces of the two mounting plates are co-planar, and the two plates together occupy just the thickness T, not twice the thickness T. The first mounting plate 152 is attached to the inner lateral surface 132 of first member 120-1, extending inward beyond inner lateral surface 132 by the thickness T. The second mounting plate 152 is attached to the perimeter stile-face 220 of one of the stiles 210 of nonmetallic shutter panel 200. At least before the hinge 150 is installed, mounting plates 152 are configured to swing past each other without impacting each other face-to-face.

In this exemplary embodiment, nonmetallic shutter panel 200, including the stiles 210 and rails 240 of panel frame 205 and the louvers 250, comprise or are formed from nonmetallic materials such as wooden materials, plastic materials (e.g., PVC), and/or other nonmetallic materials including such materials which may be configured to have the appearance of wooden materials to enhance the aesthetic appearance of the nonmetallic shutter panel 200 where the nonmetallic shutter panel 200 is protected (e.g., from sources of corrosion, external loads) by the surrounding metallic shutter frame 110 made instead from a high strength, corrosion resistant metallic material. In some embodiments, only pins 252 of nonmetallic shutter panel 200 may comprise metallic materials, with the remaining components of nonmetallic shutter panel 200 comprising only nonmetallic materials. In this manner, comprising both a metallic shutter frame 110 and a nonmetallic shutter panel 200 forms or defines a composite shutter assembly 100 which may be particularly useful for indoor applications in which greater protection will be provided to the nonmetallic shutter panel 200 from the outdoor ambient environment.

In some embodiments, nonmetallic shutter panel 200 is fabricated having cosmetic louvers; as examples, the louvers are rigidly mounted to a panel frame, or the louvers are integral, forming a single unit with the panel frame. In certain other embodiments, the nonmetallic shutter panel 200 is replaced by a panel having no louvers, but including one or more of the light-blocking features of nonmetallic shutter panel 200. Additionally, although composite shutter assembly 100, metallic shutter frame 110, and nonmetallic shutter panel 200 have been shown as rectangular, in various embodiments, a composite shutter assembly, a frame, or a nonmetallic shutter panel that is fabricated in accordance with principles described herein is configured to fit a non-rectangular window or door frame, such as a hexagonal window casing. In some instances, to accomplish an aesthetic, economic, scheduling, or functional advantage composite shutter assembly 100 may be coupled to an opening, a casing or another frame in a building even though the opening, casing, or other frame has no window or door. In some instances, composite shutter assembly 100 may function as a casing or as a door, according to its capability.

Although various embodiments were described as having non-mortise hinges, some embodiments may use a mortise hinge mounted in a mortise, i.e. a recess that is cut to match the size of the hinge, or even a mortise hinge mounted in a shutter recessed surface that is longer than the hinge and may extend the full-length of a stile, such as shutter recessed surface 226 for example. Various mortise hinges include a pair of mounting plates attached by a pin for rotation, the attachment being such that the mounting plates are positioned face-to-face when closed, potentially impacting each other and limited to less than 360 degrees of relative rotation.

While exemplary embodiments have been shown and described, modifications thereof can be made by one of ordinary skill in the art without departing from the scope or teachings herein. The embodiments described herein are exemplary only and are not limiting. Many variations and modifications of the apparatuses and processes described herein are possible and are within the scope of the disclosure. Accordingly, the scope of protection is not limited to the embodiments described herein, but is only limited by the claims that follow, the scope of which shall include all equivalents of the subject matter of the claims.

What is claimed is:

1. A composite shutter assembly comprising:
a metallic shutter frame comprising a pair of elongate side members and a pair of elongate cross members extending between the pair of side members; and
a nonmetallic shutter panel comprising a first stile pivotally coupled to a first side member of the pair of side members of the metallic shutter frame, the nonmetallic shutter panel configured to swing between a closed position and an open position relative to the metallic shutter frame.

2. The composite shutter assembly of claim 1, wherein the first side member of the metallic shutter frame includes an inwardly-facing frame surface in a region between the pair of cross members, and a frame-ledge.

3. The composite shutter assembly of claim 1, wherein each of the pair of side members and the pair of cross members each comprise metallic materials.

4. The composite shutter assembly of claim 1, wherein the metallic shutter frame comprises aluminum.

5. The composite shutter assembly of claim 1, wherein the nonmetallic shutter panel comprises at least one of a wooden material or a plastic material.

6. The composite shutter assembly of claim 1 wherein:
the nonmetallic shutter panel further comprises a front shutter-face, a perimeter shutter-face, and a rear shutter-face opposite the front shutter-face; and
the metallic shutter frame defines a first surface parallel and facing the rear shutter-face of the nonmetallic shutter panel when the nonmetallic shutter panel is closed, and an additional second surface parallel and facing the perimeter shutter-face when the nonmetallic shutter panel is closed.

7. The composite shutter assembly of claim 1 further comprising a plurality of hinges having at least one mounting plate mounted to the nonmetallic shutter panel or at least one mounting plate coupled to the metallic shutter frame.

8. The composite shutter assembly of claim 1, wherein at least one of:
a ratio of a width of a front frame-face of the metallic shutter frame to a width of one of the side members or cross members of the metallic shutter frame is between 0.1 and 0.3;
a ratio of a thickness of a front frame-face of the metallic shutter frame to the width of one of the side members or cross members of the metallic shutter frame is between 0.1 and 0.2; or
a ratio of a thickness of the front frame-face of the metallic shutter frame to a depth of one of the side members or cross members of the metallic shutter frame is between 0.1 and 0.3.

9. A composite shutter assembly comprising:
a metallic shutter frame comprising a pair of elongate side members and a pair of elongate cross members extending between the pair of side members; and
a nonmetallic shutter panel comprising a first stile moveably coupled to a first side member of the pair of side members of the metallic shutter frame, the nonmetallic shutter panel configured to shift between a closed position and an open position relative to the metallic shutter frame.

10. The composite shutter assembly of claim 9, wherein at least one of:
a ratio of a width of a front frame-face of the metallic shutter frame to a width of one of the side members or cross members of the metallic shutter frame is between 0.1 and 0.3;
a ratio of a thickness of a front frame-face of the metallic shutter frame to the width of one of the side members or cross members of the metallic shutter frame is between 0.1 and 0.2; or
a ratio of a thickness of the front frame-face of the metallic shutter frame to a depth of one of the side members or cross members of the metallic shutter frame is between 0.1 and 0.3.

11. The composite shutter assembly of claim 9, wherein the first side member of the metallic shutter frame includes an inwardly-facing frame surface in a region between the pair of cross members, and a frame-ledge.

12. The composite shutter assembly of claim 9, wherein each of the pair of side members and the pair of cross members each comprise metallic materials.

13. The composite shutter assembly of claim 9, wherein at least one of the metallic shutter frame comprises aluminum or the nonmetallic shutter panel comprises at least one of a wooden material or a plastic material.

14. A composite shutter assembly comprising:
a metallic shutter frame comprising:
a first side member and a second side member;
a first cross member and a second cross member extending between the first side member and the second side member and spaced apart from one another, wherein at least one of the first side member, the second side member, the first cross member, or the second cross member comprises a metallic material; and
a nonmetallic shutter panel pivotally coupled to the metallic shutter frame, the nonmetallic shutter panel comprising:
a first stile and a second stile; and
a first rail and a second rail extending between the first stile and the second stile and spaced apart from one another; and
a louver pivotably coupled to the first stile and the second stile, wherein at least one of the first stile, the second stile, the first rail, the second rail, or the louver comprises a nonmetallic material.

15. The composite shutter assembly of claim 14, wherein at least one of the metallic material comprises aluminum or the nonmetallic material comprises at least one of a wooden material or a plastic material.

16. The composite shutter assembly of claim 14, wherein the first side member of the metallic shutter frame includes an inwardly-facing frame surface in a region between the first cross member and the second cross member, and a frame-ledge.

17. The composite shutter assembly of claim 14, wherein each of the first side member, the second side member, the first cross member, and the second cross member comprise metallic materials.

18. The composite shutter assembly of claim 14, further comprising one or more hinges having at least one mounting plate mounted to the nonmetallic shutter panel or at least one mounting plate coupled to the metallic shutter frame.

19. The composite shutter assembly of claim 14, wherein at least one of:
a ratio of a width of a front frame-face of the metallic shutter frame to a width of one of the side members or cross members of the metallic shutter frame is between 0.1 and 0.3;
a ratio of a thickness of a front frame-face of the metallic shutter frame to the width of one of the first side member and the second side member or cross members of the metallic shutter frame is between 0.1 and 0.2; or
a ratio of a thickness of the front frame-face of the metallic shutter frame to a depth of one of the side members or cross members of the metallic shutter frame is between 0.1 and 0.3.

20. The composite shutter assembly of claim 14, wherein the metallic shutter frame has an L-shaped cross-section comprising a first frame member and a second frame member extending orthogonally the second frame member.
